(19) United States
(12) Patent Application Publication
(10) Pub. No.: US 2011/0206165 A1
(43) Pub. Date: Aug. 25, 2011

(54) MOBILE WIRELESS APPARATUS

(75) Inventors: Hiroshi Satou, Kanagawa (JP); Yoshio Koyanagi, Kanagawa (JP); Yoshihiro Kanasaki, Ishikawa (JP); Kouta Aoki, Kanagawa (JP)

(73) Assignee: PANASONIC CORPORATION, Osaka (JP)

(21) Appl. No.: 13/126,743

(22) PCT Filed: Oct. 20, 2009
(86) PCT No.: PCT/JP2009/005501

§ 371 Date: Apr. 28, 2011

(30) Foreign Application Priority Data
Oct. 30, 2008 (JP) 2008-280335

(51) Int. Cl. H04L 27/06

(52) U.S. Cl. 375/340

(57) ABSTRACT

A mobile wireless apparatus wherein matching circuits can be independently designed, while the increase in the circuit scale can be suppressed and the cost can be reduced. In this apparatus, a filter (102) suppresses a frequency band (f2-f3) of signals received by an antenna element (101). A filter (105) suppresses a frequency band (f1) of the signals received by the antenna element (101). A wireless unit (104) acquires data that is obtained by demodulating the signals obtained by suppressing the frequency band (f2-f3) and superimposing the demodulated signals on the signals of the frequency band (f1). A wireless unit (107) acquires data that is obtained by demodulating the signals obtained by suppressing the frequency band (f1) and superimposing the demodulated signals on the signals of the frequency band (f2-f3). A matching circuit (103), which is connected between the filter (102) and the wireless unit (104), matches the impedances of the filter (102) and wireless unit (104). A matching circuit (106), which is connected between the filter (105) and the wireless unit (107), matches the impedances of the filter (105) and wireless unit (107).

### TECHNICAL FIELD

The present invention relates to a portable radio apparatus, and more particularly, to a portable radio apparatus that simultaneously operates a plurality of radio systems by sharing one antenna element.

### BACKGROUND ART

In recent years, the number of radio systems mounted on a portable radio apparatus has been ever increasing. Furthermore, in recent years, portable radio apparatuses are becoming smaller in size and thickness and it is therefore more difficult to accommodate as many antenna elements as radio systems mounted in their housings. Therefore, conventionally, such a portable radio apparatus is sharing antenna elements among a plurality of radio systems. That is, the conventional portable radio apparatus is mounted with an antenna element that supports a plurality of radio systems.

Such a portable radio apparatus shares an antenna element by switching connections between the antenna element and a receiver provided for each radio system using a switch according to the transmitting/receiving radio systems. However, such a portable radio apparatus has a problem of being unable to simultaneously operate a plurality of radio systems.

As a portable radio apparatus to solve such a problem, a portable radio apparatus is known which shares an antenna element by using filters of different pass frequencies according to a transmitting/receiving radio system (e.g. Patent Literature 1). The portable radio apparatus according to Patent Literature 1 can simultaneously operate a plurality of radio systems.

### Citation List

### Patent Literature

### PTL 1

### National Publication of International Patent Application No. 2004-523993

### SUMMARY OF INVENTION

### Technical Problem

However, according to Patent Literature 1, a matching circuit of a receiving system is arranged before a filter and a signal after impedance conversion by the matching circuit is inputted to the filter, which results in a problem that it is not possible to independently design each matching circuit. That is, according to Patent Literature 1, if a constant of each matching circuit is changed, optimum constants of other matching circuits are also changed, and it is necessary to consider influences from the other matching circuits when designing each matching circuit. Furthermore, according to Patent Literature 1, it is necessary to perform frequency tuning using a duplexer to handle a plurality of frequencies, which results in a problem that the circuit scale increases, and hence an increase in manufacturing cost.

The present invention has been implemented in view of such problems and it is therefore an object of the present invention to provide a portable radio apparatus capable of independently designing each matching circuit, suppressing increases in the circuit scale and reducing manufacturing cost.

### Solution to Problem

A portable radio apparatus according to the present invention adopts a configuration including an antenna, a first suppressing section that suppresses a first frequency band of a signal received through the antenna, a second suppressing section that suppress a second frequency band of the signal received through the antenna, a first radio section that demodulates the signal of the suppressed first frequency band and acquires data superimposed on the signal of the second frequency band, a second radio section that demodulates the signal of the suppressed second frequency band and acquires data superimposed on the signal of the first frequency band, a first matching circuit connected between the first suppressing section and the first radio section to provide impedance matching between the first suppressing section and the first radio section, and a second matching circuit connected between the second suppressing section and the second radio section to provide impedance matching between the second suppressing section and the second radio section.

### Advantageous Effects of Invention

According to the present invention, it is possible to independently design each matching circuit, suppress increases in the circuit scale and reduce manufacturing cost.

### BRIEF DESCRIPTION OF DRAWINGS

FIG. 1 is a block diagram illustrating a configuration of a portable radio apparatus according to Embodiment 1 of the present invention;

FIG. 2 is a diagram illustrating band-pass characteristics of a filter according to Embodiment 1 of the present invention;

FIG. 3 is a diagram illustrating band-pass characteristics of a filter according to Embodiment 1 of the present invention;

FIG. 4 is a diagram illustrating an operation of conversion to a characteristic impedance through a matching circuit according to Embodiment 1 of the present invention;

FIG. 5 is a diagram illustrating an operation of conversion to a complex conjugate impedance through the matching circuit according to Embodiment 1 of the present invention;

FIG. 6 is a block diagram illustrating a configuration of a portable radio apparatus according to Embodiment 2 of the present invention;

FIG. 7 is a diagram illustrating an impedance at an output of an antenna element according to Embodiment 2 of the present invention;

FIG. 8 is a diagram illustrating an impedance at an output of a filter according to Embodiment 2 of the present invention;

FIG. 9 is a diagram illustrating an impedance at an output of a matching circuit according to Embodiment 2 of the present invention;

FIG. 10 is a diagram illustrating an impedance at an output of the antenna element according to Embodiment 2 of the present invention;

FIG. 11 is a diagram illustrating an impedance at an output of the filter according to Embodiment 2 of the present invention;

FIG. 12 is a diagram illustrating an impedance at an output of the matching circuit according to Embodiment 2 of the present invention;

FIG. 13 is a diagram illustrating an impedance at an output of an amplifier according to Embodiment 2 of the present invention;

FIG. 14 is a block diagram illustrating a configuration of a portable radio apparatus according to Embodiment 3 of the present invention;

FIG. 15 is a block diagram illustrating a configuration of a portable radio apparatus according to Embodiment 4 of the present invention; and

FIG. 16 is a block diagram illustrating a configuration of a portable radio apparatus according to Embodiment 5 of the present invention.

### DESCRIPTION OF EMBODIMENTS

Hereinafter, embodiments of the present invention will be described in detail with reference to the accompanying drawings.

### Embodiment 1

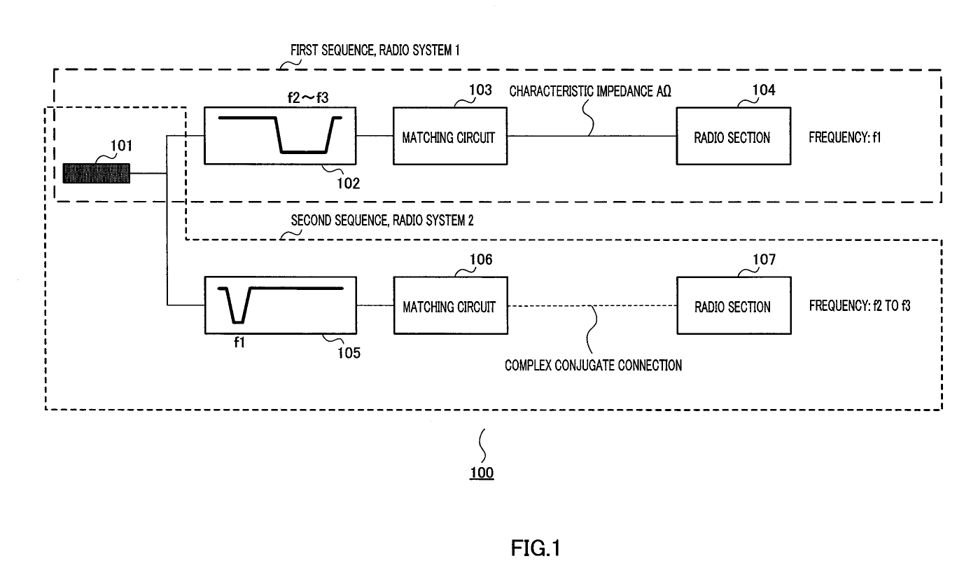

FIG. 1 is a block diagram illustrating a configuration of portable radio apparatus 100 according to Embodiment 1 of the present invention.

Portable radio apparatus 100 is mainly comprised of antenna 101, filter 102, matching circuit 103, radio section 104, filter 105, matching circuit 106 and radio section 107.

Furthermore, in portable radio apparatus 100, a sequence (hereinafter referred to as “first sequence”) made up of antenna 101, filter 102, matching circuit 103 and radio section 104 performs both transmission processing of superimposing data on a signal of frequency f1 and reception processing of acquiring data superimposed on a signal of frequency f1. Furthermore, in portable radio apparatus 100, a sequence (hereinafter referred to as “second sequence”) made up of antenna 101, filter 105, matching circuit 106 and radio section 107 performs only reception processing of acquiring data superimposed on a signal of frequency f2 to frequency f3.

Here, the data superimposed on the signal processed in the first sequence is, for example, data of Bluetooth (registered trademark) and the data superimposed on the signal processed in the second sequence is, for example, data of digital television.

Hereinafter, the components of portable radio apparatus 100 will be described in detail.

Antenna 101 functions as a mono-pole antenna and has an antenna element having an electrical length of ¼ wavelength or less. Antenna 101 receives a signal of radio system 1 using frequency f1 and a signal of radio system 2 using a signal of frequency f2 to frequency f3 and outputs each received signal to filter 102 and filter 105. Furthermore, antenna 101 transmits a signal of radio system 1 using frequency f1 inputted from filter 102. Here, radio system 2 has a wider band than radio system 1. Furthermore, frequency f1 is, for example, 2450 MHz. On the other hand, frequency f2 is, for example, 475 MHz. Frequency f3 is, for example, 650 MHz.

Filter 102 is, for example, a band elimination filter (BEF) which suppresses frequency f2 to frequency f3 of the signal inputted from antenna 101 and outputs the signal of suppressed frequency f2 to frequency f3 to matching circuit 103. Furthermore, filter 102 suppresses frequency f2 to frequency f3 of the signal inputted from matching circuit 103 and outputs the signal of suppressed frequency f2 to frequency f3 to antenna 101. That is, filter 102 suppresses frequency f2 to frequency f3 used in radio system 2 processed in the second sequence other than radio system 1 processed in the first sequence. For filter 102, it is preferable to use a filter with the lowest possible pass loss of frequency f1.

Matching circuit 103 is connected in series between filter 102 and radio section 104 which will be described later and realizes impedance matching between filter 102 and radio section 104. To be more specific, matching circuit 103 converts an impedance of the signal inputted from filter 102 to characteristic impedance An.

Radio section 104 demodulates the signal inputted from matching circuit 103 and acquires data superimposed on frequency f1.

Furthermore, radio section 104 performs modulation of superimposing data on frequency f1 and outputs the modulated signal to matching circuit 103.

Filter 105 is, for example, a band elimination filter (BEF) which suppresses frequency f1 of the signal inputted from antenna 101 and outputs the signal of suppressed frequency f1 to matching circuit 106. That is, filter 105 suppresses frequency f1 used in radio system 1 processed in the first sequence other than radio system 2 processed in the second sequence. For filter 105, it is preferable to use a filter with the lowest possible pass loss of frequency f2 to frequency f3.

Matching circuit 106 is connected in series between filter 105 and radio section 107 which will be described later and realizes impedance matching between filter 105 and radio section 107. To be more specific, matching circuit 106 converts the impedance of the signal inputted from filter 105 so that an output impedance of matching circuit 106 and an input impedance of radio section 107 have a complex conjugate relationship and outputs the signal to radio section 107.

Radio section 107 demodulates the signal inputted from matching circuit 106 and acquires data superimposed on frequency f2 to frequency f3.

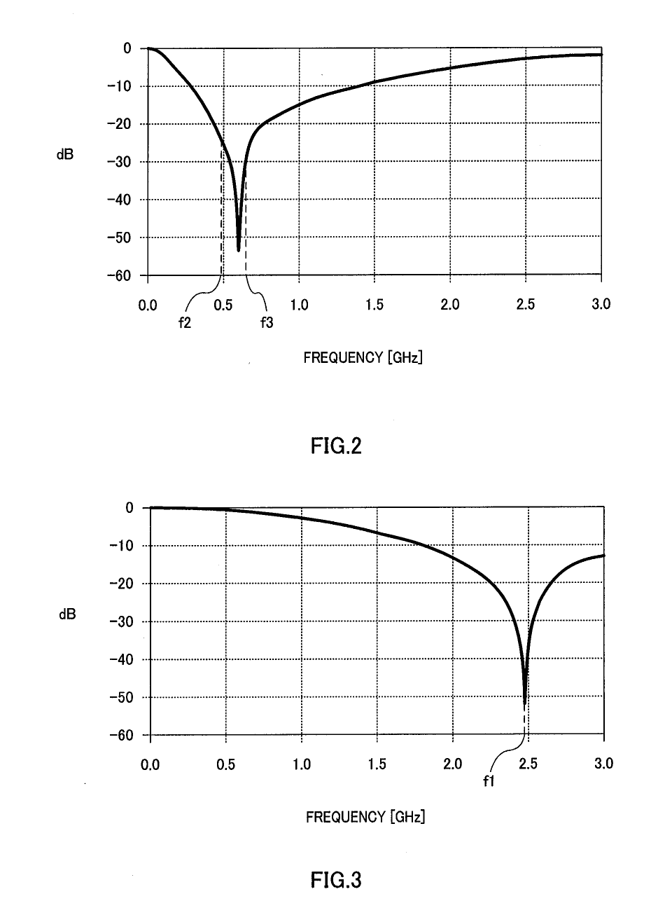

FIG. 2 is a diagram illustrating band-pass characteristics of filter 102 and FIG. 3 is a diagram illustrating band-pass characteristics of filter 105.

Next, operations of matching circuit 103 and matching circuit 106 will be described.

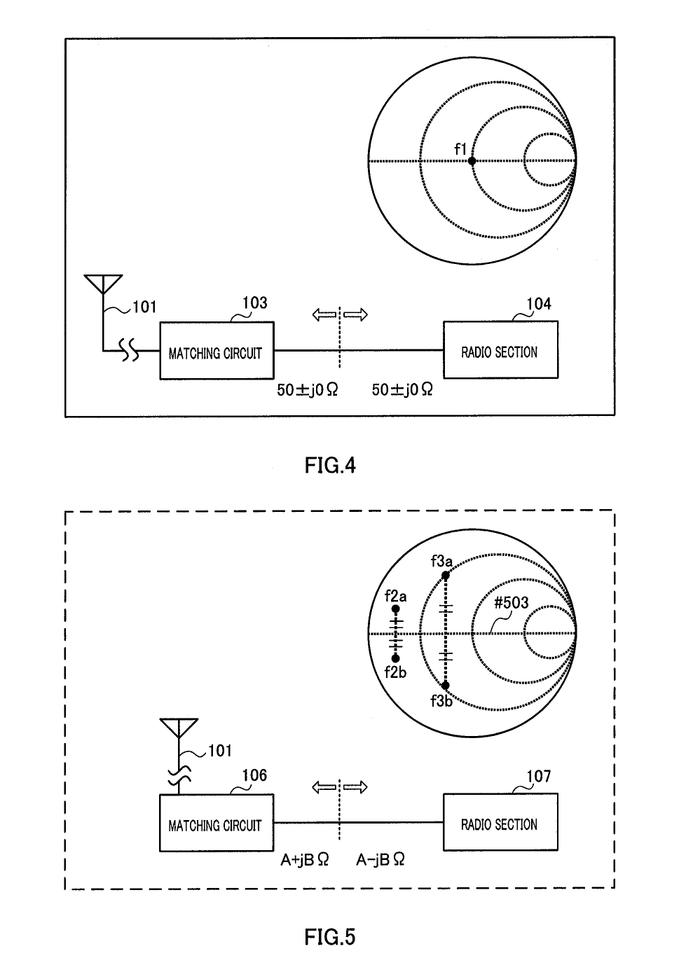

FIG. 4 is a diagram illustrating an operation of conversion to a characteristic impedance through matching circuit 103.

As shown in FIG. 4, when, for example, the impedance of radio section 104 is Z=50±j0Ω, when matching the impedance at the output of matching circuit 103, impedance conversion is performed so as to obtain impedance Z=50±j0Ω. As a result, after matching circuit 103 performs impedance conversion to characteristic impedance An, a point on a Smith chart is plotted at the position of f1 which is the center of the Smith chart.

FIG. 5 is a diagram illustrating an operation of conversion to a complex conjugate impedance through matching circuit 106.

As shown in FIG. 5, if the input impedance of radio section 107 is, for example, Z2=A−jB Ω at a predetermined frequency, when matching circuit 106 performs matching of the output impedance, matching circuit 106 performs impedance conversion so that output impedance Z1 becomes Z1=A+jB Ω. After converting impedance so that output impedance Z1 of matching circuit 106 and input impedance Z2 of radio section 107 have a complex conjugate relationship, points on the Smith chart are plotted at positions of f2a and f2b for frequency f2 and plotted at positions of f3a and f3b for frequency f3. Plotted f2a and f2b are plotted at positions symmetric with respect to horizontal axis #503. Likewise, plotted f3a and f3b are plotted at positions symmetric with respect to horizontal axis #503.

Receiving a signal of wide band radio system 2 of 475 MHz to 650 MHz generally requires an antenna element having a length of 16 cm to 12 cm which is ¼ wavelength. However, according to the present embodiment, matching circuit 106 performs impedance conversion of the signal inputted from filter 105 so that the output impedance of matching circuit 106 and the input impedance of radio section 107 have a complex conjugate relationship in wide band radio system 2 of 475 MHz to 650 MHz. In the present embodiment, this eliminates the necessity of obtaining a characteristic impedance which has a constant value over an entire desired band using an antenna element alone, and it is thereby possible to receive a signal of radio system 2 through antenna 101 with an antenna element having a length of approximately 5 cm.

Thus, the present embodiment provides a filter that suppresses a frequency used in another radio system between the matching circuit and the antenna, and thereby prevents, when simultaneously transmitting or receiving signals of a plurality of different radio systems, the matching circuit of each radio system from receiving influences of impedance of the other radio system, and can independently design each matching circuit, suppress increases in the circuit scale and reduce manufacturing cost. Furthermore, the present embodiment converts a signal of a wide band radio system to a complex conjugate impedance, and can thereby receive a signal of a wide band radio system through an antenna element of a smaller electrical length than a normal length and thus reduce the size and thickness of the housing when accommodating the antenna elements in the housing.

### Embodiment 2

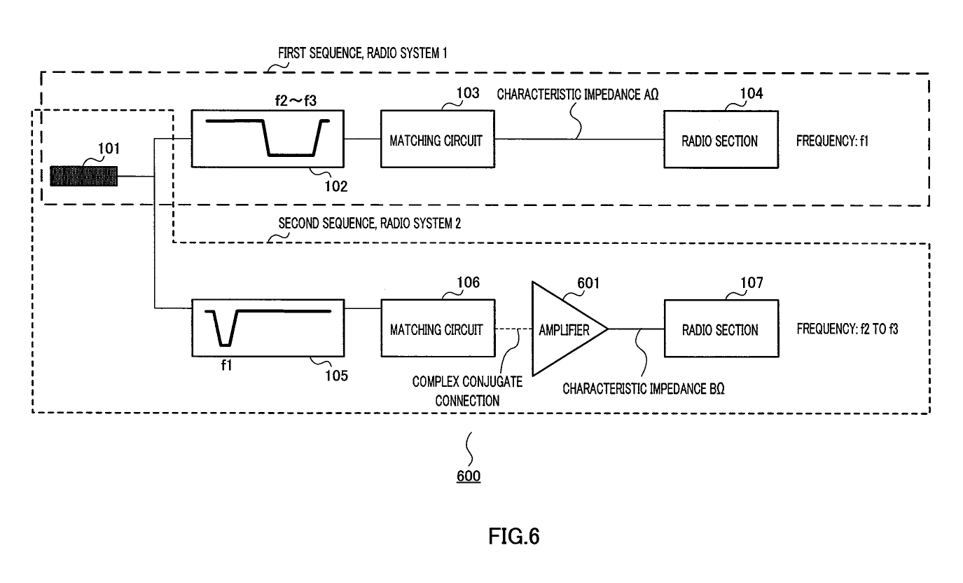

FIG. 6 is a block diagram illustrating a configuration of portable radio apparatus 600 according to Embodiment 2 of the present invention.

Portable radio apparatus 600 shown in FIG. 6 adds amplifier 601 to portable radio apparatus 100 according to Embodiment 1 shown in FIG. 1. In FIG. 6, the same components as those in FIG. 1 will be assigned the same reference numerals and descriptions thereof will be omitted.

Portable radio apparatus 600 is mainly comprised of antenna 101, filter 102, matching circuit 103, radio section 104, filter 105, matching circuit 106, amplifier 601 and radio section 107.

Furthermore, a sequence made up of antenna 101, filter 105, matching circuit 106, amplifier 601 and radio section 107 in portable radio apparatus 600 performs only reception processing of acquiring data superimposed on a signal of frequency f2 to frequency f3.

Matching circuit 106 is connected in series between filter 105 and amplifier 601 which will be described later to provide impedance matching between filter 105 and amplifier 601. To be more specific, matching circuit 106 converts the impedance of a signal inputted from filter 105 so that the impedance of the signal inputted from filter 105 and the input impedance of radio section 107 have a complex conjugate relationship and outputs the converted impedance to amplifier 601.

Amplifier 601 amplifies the signal inputted from matching circuit 106 and outputs the amplified signal to radio section 107. In this case, for amplifier 601, the input impedance is impedance of a complex number and the output impedance is characteristic impedance BΩ. Furthermore, amplifier 601 has a gain of 0 dB or more at frequency f2 to frequency f3 and it is preferable to use an amplifier having the highest possible gain at frequency f2 to frequency f3 and having a low noise factor (NF) as well.

Radio section 107 demodulates the signal inputted from amplifier 601 and acquires data superimposed on frequency f2 to frequency f3.

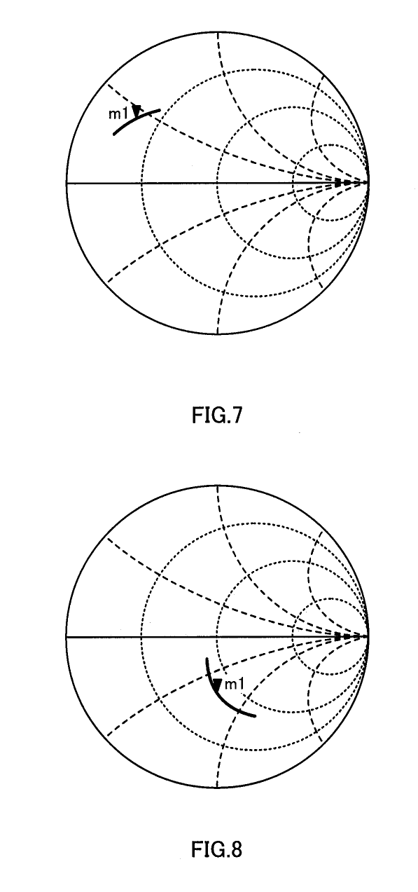

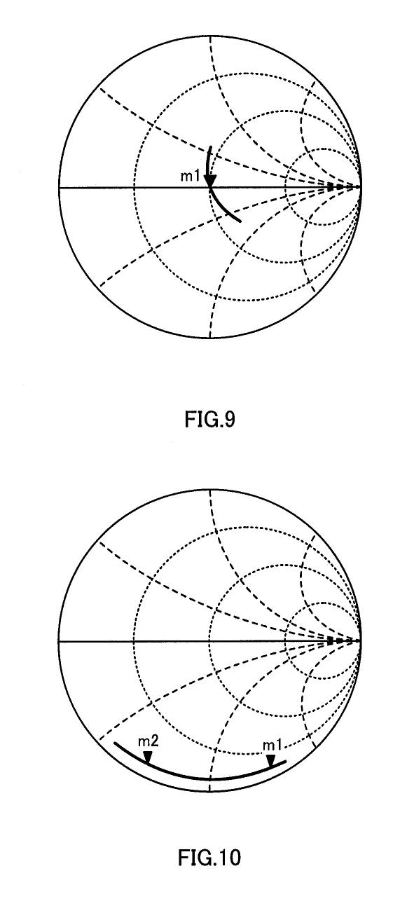

FIG. 7 to FIG. 9 are diagrams illustrating an impedance variation in the first sequence on a Smith chart and FIG. 10 to FIG. 13 are diagrams illustrating an impedance variation in the second sequence on a Smith chart.

FIG. 7 is a diagram illustrating an impedance at the output of antenna 101, FIG. 8 is a diagram illustrating an impedance at the output of filter 102 and FIG. 9 is a diagram illustrating an impedance at the output of matching circuit 103.

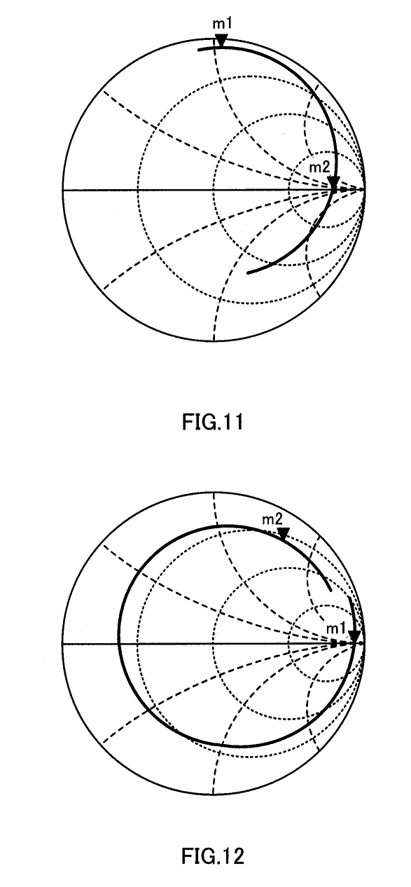

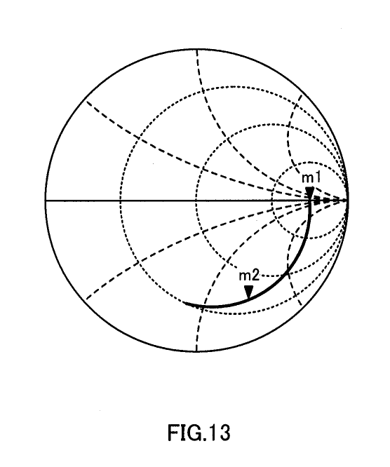

Furthermore, FIG. 10 is a diagram illustrating an impedance at the output of antenna 101, FIG. 11 is a diagram illustrating an impedance at the output of filter 105, FIG. 12 is a diagram illustrating an impedance at the output of matching circuit 106 and FIG. 13 is a diagram illustrating an impedance at the input of amplifier 601.

In FIG. 7, ml corresponds to frequency=2.450 GHz and impedance=10.993+j22.494Ω. Furthermore, in FIG. 8, ml corresponds to frequency=2.450 GHz and impedance=36.954-j35.859Ω. Furthermore, in FIG. 9, ml corresponds to frequency=2.450 GHz and impedance=49.982+j0.104Ω.

Furthermore, in FIG. 10, ml corresponds to frequency 475.0 MHz and impedance=5.815-j70.250Ω, and m2 corresponds to frequency=650.0 MHz and impedance=3.708-j35.137Ω. In FIG. 11, m1 corresponds to frequency=475.0 MHz and impedance=2.873+j51.631Ω, and m2 corresponds to frequency=650.0 MHz and impedance=335.853+j19.710Ω. On the other hand, in FIG. 12, m1 corresponds to frequency=475.0 MHz and impedance=788.899-j40.139Ω, and m2 corresponds to frequency=650.0 MHz and impedance=20.671+j78.636Ω. In FIG. 13, m1 corresponds to frequency=475.0 MHz and impedance=336.234-j14.243Ω, and m2 corresponds to frequency=650.0 MHz and impedance=29.228-j71.516Ω.

The present embodiment processes a signal of a radio system that performs transmission in the first sequence and processes a signal of a radio system that performs only reception and a signal of a radio system that uses a band within the band of amplifier 601 in the second sequence.

Thus, the present embodiment provides a filter that suppresses a frequency used in another radio system between a matching circuit and an antenna, a matching circuit of each radio system is not affected by an impedance of the other radio system when simultaneously receiving signals of a plurality of different radio systems, and it is thereby possible to independently design each matching circuit, suppress increases in the circuit scale and reduce manufacturing cost. Furthermore, the present embodiment converts a signal of a wide band radio system to a complex conjugate impedance, thus enables a signal of the wide band radio system to be received with an antenna element having a smaller electrical length than a normal length, and can thereby reduce, when accommodating the antenna element in a housing, the size and thickness of the housing.

### Embodiment 3

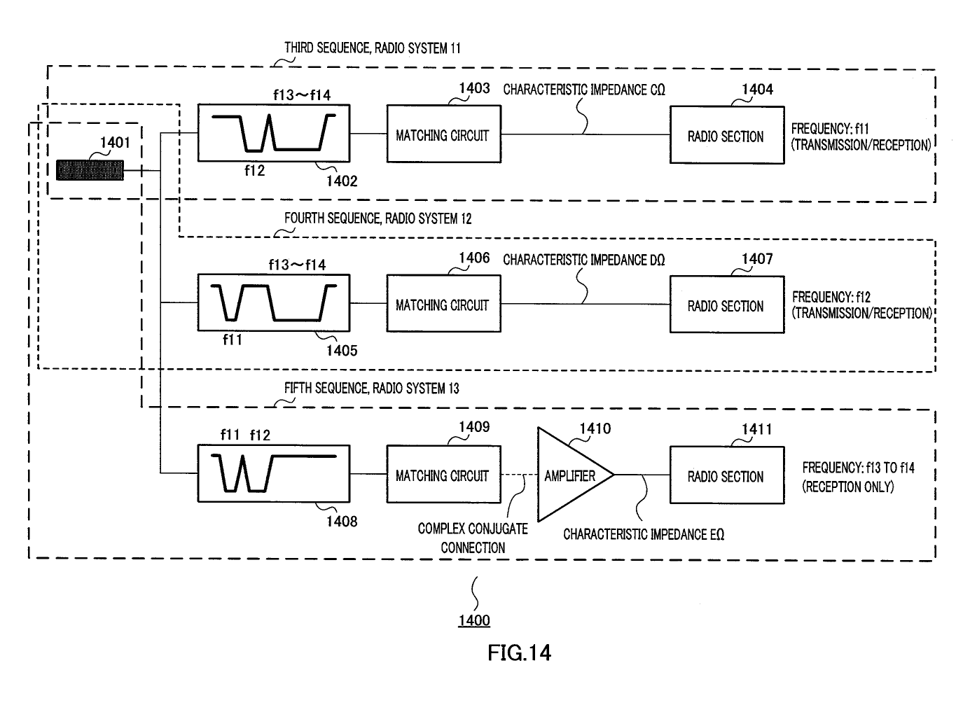

FIG. 14 is a block diagram illustrating a configuration of portable radio apparatus 1400 according to Embodiment 3 of the present invention.

Portable radio apparatus 1400 is mainly comprised of antenna 1401, filter 1402, matching circuit 1403, radio section 1404, filter 1405, matching circuit 1406, radio section 1407, filter 1408, matching circuit 1409, amplifier 1410 and radio section 1411.

In portable radio apparatus 1400, a sequence (hereinafter referred to as “third sequence”) made up of antenna 1401, filter 1402, matching circuit 1403 and radio section 1404 performs both transmission processing of superimposing data on a signal of frequency f11 and reception processing of acquiring data superimposed on a signal of frequency f11. On the other hand, in portable radio apparatus 1400, a sequence (hereinafter referred to as “fourth sequence”) made up of antenna 1401, filter 1405, matching circuit 1406, radio section 1407 performs both transmission processing of superimposing data on a signal of frequency f12 and reception processing of acquiring data superimposed on a signal of frequency f12. In portable radio apparatus 1400, a sequence (hereinafter referred to as “fifth sequence”) made up of antenna 1401, filter 1408, matching circuit 1409, amplifier 1410 and radio section 1411 performs only reception processing of acquiring data superimposed on a signal of frequency f13 to frequency f14.

Hereinafter, the components of portable radio apparatus 1400 will be described.

Antenna 1401 functions, for example, as a mono-pole antenna and includes an antenna element having an electrical length of ¼ wavelength or less. Antenna 1401 receives a signal of radio system 11 using frequency f11, a signal of radio system 12 using frequency f12 and a signal of radio system 13 using frequency f13 to frequency f14 and outputs each received signal to filter 1402, filter 1405 and filter 1408. Furthermore, antenna 1401 transmits the signal of radio system 11 using frequency f11 inputted from filter 1402 or the signal of radio system 12 using frequency f12 inputted from filter 1405. Here, radio system 13 has a wider band than radio system 11 and radio system 12.

Filter 1402 is, for example, a band elimination filter (BEF) which suppresses frequency f12, and frequency f13 to frequency f14 of a signal inputted from antenna 1401 and outputs the signal of suppressed frequency f12, and frequency f13 to frequency f14 to matching circuit 1403. Furthermore, filter 1402 suppresses frequency f12, and frequency f13 to frequency f14 of a signal inputted from matching circuit 1403 and outputs the signal of suppressed frequency f12, and frequency f13 to frequency f14 to antenna 1401. That is, filter 1402 suppresses frequency f12 used in radio system 12 processed in the fourth sequence and frequency f13 to frequency f14 used in radio system 13 processed in the fifth sequence other than radio system 11 processed in the third sequence other than radio system 11 processed in the third sequence. For filter 1402, it is preferable to use a filter with the lowest possible pass loss of frequency f11.

Matching circuit 1403 is connected in series between filter 1402 and radio section 1404 which will be described later to provide impedance matching between filter 1402 and radio section 1404. To be more specific, matching circuit 1403 converts an impedance of the signal inputted from filter 1402 to characteristic impedance CΩ.

Radio section 1404 demodulates the signal inputted from matching circuit 1403 and acquires data superimposed on frequency f11. Furthermore, radio section 1404 performs modulation of superimposing data on frequency f1 1 and outputs the modulated signal to matching circuit 1403.

Filter 1405 is, for example, a band elimination filter (BEF) which suppresses frequency f11 and frequency f13 to frequency f14 of a signal inputted from antenna 1401 and outputs the signal of suppressed frequency f11, and frequency f13 to frequency f14 to matching circuit 1406. Furthermore, filter 1405 suppresses frequency f11 and frequency f13 to frequency f14 of the signal inputted from matching circuit 1406 and outputs the signal of suppressed frequency f11, and frequency f13 to frequency f14 to antenna 1401. That is, filter 1405 suppresses frequency f11 used in radio system 11 processed in the third sequence and frequency f13 to frequency f14 used in radio system 13 processed in the fifth sequence other than radio system 12 processed in the fourth sequence. For filter 1405, it is preferable to use a filter with the lowest possible pass loss of frequency f12.

Matching circuit 1406 is connected in series between filter 1405 and radio section 1407 which will be described later to provide impedance matching between filter 1405 and radio section 1407. To be more specific, matching circuit 1406 converts an impedance of the signal inputted from filter 1405 to characteristic impedance Dn.

Radio section 1407 demodulates the signal inputted from matching circuit 1406 and acquires data superimposed on frequency f12. Furthermore, radio section 1407 performs modulation of superimposing data on frequency f12 and outputs the modulated signal to matching circuit 1406.

Filter 1408 is, for example, a band elimination filter (BEF) which suppresses frequency f11 and frequency f12 of a signal inputted from antenna 1401 and outputs the signal of suppressed frequency f11 and frequency f12 to matching circuit 1409. That is, filter 1408 suppresses frequency f11 used in radio system 11 processed in the third sequence and frequency f12 used in radio system 12 processed in the fourth sequence other than radio system 13 processed in the fifth sequence. For filter 1408, it is preferable to use a filter with the lowest possible pass loss of frequency f13 to frequency f14.

Matching circuit 1409 is connected in series between filter 1408 and amplifier 1410 which will be described later to provide impedance matching between filter 1408 and amplifier 1410. To be more specific, matching circuit 1409 converts an impedance of the signal inputted from filter 1408 so that the output impedance of matching circuit 1409 and the input impedance of amplifier 1410 have a complex conjugate relationship and outputs the converted impedance to amplifier 1410.

Amplifier 1410 amplifies the signal inputted from matching circuit 1409 and outputs the amplified signal to radio section 1411. In this case, the input impedance of amplifier 1410 and the output impedance of matching circuit 1409 have a complex conjugate relationship and the output impedance of amplifier 1410 is characteristic impedance EΩ. Furthermore, for amplifier 1410, it is preferable to use an amplifier having a gain of 0 dB or more at frequency f13 to frequency f14, having the highest possible gain at frequency f13 to frequency f14 and having a low noise factor (NF) as well.

Radio section 1411 demodulates the signal inputted from amplifier 1410 and acquires data superimposed on frequency f13 to frequency f14.

In the present embodiment, a signal of a radio system that performs transmission is processed in the third sequence or fourth sequence, and a signal of a radio system that performs only reception and a signal of a radio system using a band within the band of amplifier 1410 are processed in the fifth sequence.

Thus, according to the present embodiment, effects similar to those of Embodiment 1 can be obtained with the portable radio apparatus made up of three processing sequences; the third sequence and fourth sequence performing transmission/reception processing and the fifth sequence performing only reception processing. Furthermore, the present embodiment uses an amplifier having the highest possible gain in the reception band and having a low noise factor (NF) as well, thereby suppresses increases in noise as much as possible, and can thereby amplify a desired received signal and improve reception sensitivity.

In the present embodiment, although the signal of radio system 13 is amplified by the amplifier, the present invention is not limited to this but the amplifier may be removed.

### Embodiment 4

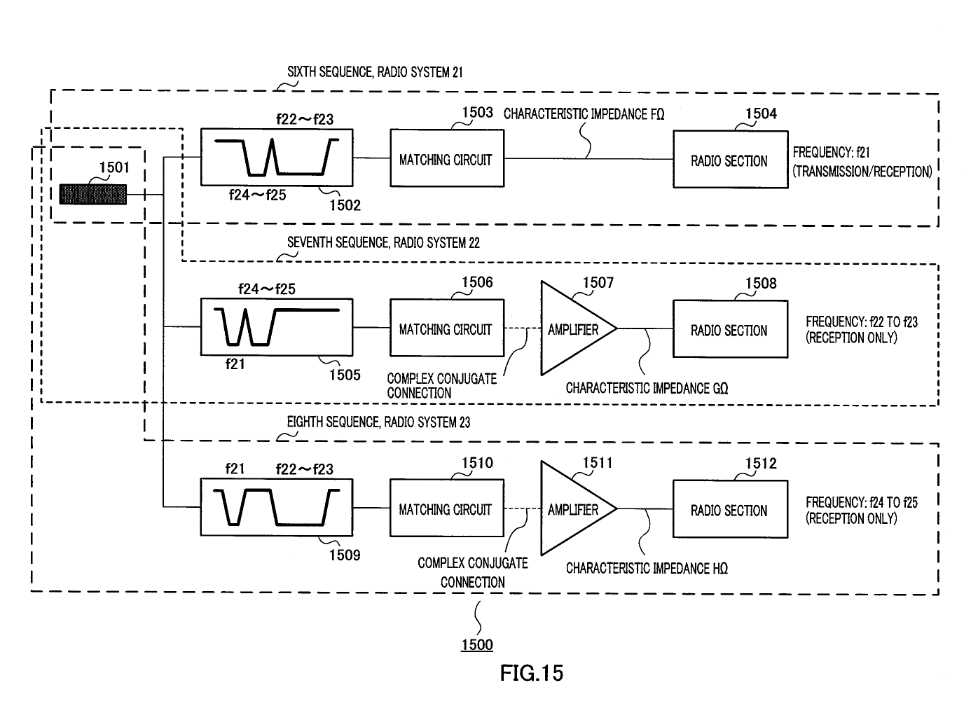

FIG. 15 is a block diagram illustrating a configuration of portable radio apparatus 1500 according to Embodiment 4 of the present invention.

Portable radio apparatus 1500 is mainly comprised of antenna 1501, filter 1502, matching circuit 1503, radio section 1504, filter 1505, matching circuit 1506, amplifier 1507, radio section 1508, filter 1509, matching circuit 1510, amplifier 1511 and radio section 1512.

Furthermore, in portable radio apparatus 1500, a sequence (hereinafter referred to as “sixth sequence”) made up of antenna 1501, filter 1502, matching circuit 1503 and radio section 1504 performs both transmission processing of superimposing data on a signal of frequency f21 and reception processing of acquiring data superimposed on a signal of frequency f21. Furthermore, in portable radio apparatus 1500, a sequence (hereinafter referred to as “seventh sequence”) made up of antenna 1501, filter 1505, matching circuit 1506, amplifier 1507 and radio section 1508 performs only reception processing of acquiring data superimposed on a signal of frequency f22 to frequency f23. Furthermore, in portable radio apparatus 1500, a sequence (hereinafter referred to as “eighth sequence”) made up of antenna 1501, filter 1509, matching circuit 1510, amplifier 1511 and radio section 1512 performs only reception processing of acquiring data superimposed on a signal of frequency f24 to frequency f25.

Hereinafter, the components of portable radio apparatus 1500 will be described in detail.

Antenna 1501 functions, for example, as a mono-pole antenna and has an antenna element having an electrical length of ¼ wavelength or less. Antenna 1501 receives a signal of radio system 21 using frequency f21, a signal of radio system 22 using frequency f22 to frequency f23 and a signal of radio system 23 using frequency f24 to frequency f25, and outputs each received signal to filter 1502, filter 1505 and filter 1509. Furthermore, antenna 1501 transmits a signal of radio system 21 using frequency f21 inputted from filter 1502. Here, radio system 22 and radio system 23 have a wider band than radio system 21.

Filter 1502 is, for example, a band elimination filter (BEF) which suppresses frequency f22 to frequency f23 and frequency f24 to frequency f25 of the signal inputted from antenna 1501 and outputs the signal of suppressed frequency f22 to frequency f23 and frequency f24 to frequency f25 to matching circuit 1503. Furthermore, filter 1502 suppresses frequency f22 to frequency f23 and frequency f24 to frequency f25 of the signal inputted from matching circuit 1503 and outputs the signal of suppressed frequency f22 to frequency f23 and frequency f24 to frequency f25 to antenna 1501. That is, filter 1502 suppresses frequency f22 to frequency f23 used in radio system 22 processed in the seventh sequence and frequency f24 to frequency f25 used in radio system 23 processed in the eighth sequence other than radio system 21 processed in the sixth sequence. For filter 1502, it is preferable to use a filter with the lowest possible pass loss of frequency f21.

Matching circuit 1503 is connected in series between filter 1502 and radio section 1504 which will be described later to provide impedance matching between filter 1502 and radio section 1504. To be more specific, matching circuit 1503 converts an impedance of the signal inputted from filter 1502 to characteristic impedance Fn.

Radio section 1504 demodulates the signal inputted from matching circuit 1503 and acquires data superimposed on frequency f21. Furthermore, radio section 1504 performs modulation of superimposing data on frequency f21 and outputs the modulated signal to matching circuit 1503.

Filter 1505 is, for example, a band elimination filter (BEF) which suppresses frequency f21 and frequency f24 to frequency f25, and outputs the signal of suppressed frequency f21 and frequency f24 to frequency f25 to matching circuit 1506. That is, filter 1505 suppresses frequency f21 used in radio system 21 processed in the sixth sequence and frequency f24 to frequency f25 used in radio system 23 processed in the eighth sequence other than radio system 22 processed in the seventh sequence. For filter 1505, it is preferable to use a filter with the lowest possible pass loss of frequency f22 to frequency f23.

Matching circuit 1506 is connected in series between filter 1505 and amplifier 1507 which will be described later to provide impedance matching between filter 1505 and amplifier 1507. To be more specific, matching circuit 1506 converts an impedance of the signal inputted from filter 1505 so that the output impedance of matching circuit 1506 and the input impedance of amplifier 1507 have a complex conjugate relationship and outputs the converted impedance to amplifier 1507.

Amplifier 1507 amplifies the signal inputted from matching circuit 1506 and outputs the amplified signal to radio section 1508. In this case, the input impedance of amplifier 1507 and the output impedance of matching circuit 1506 have a complex conjugate relationship and the output impedance of amplifier 1507 is characteristic impedance G. Furthermore, amplifier 1507 has a gain of 0 dB or more at frequency f22 to frequency f23 and it is preferable to use an amplifier having the highest possible gain at frequency f22 to frequency f23 and having a low noise factor (NF) as well.

Radio section 1508 demodulates the signal inputted from amplifier 1507 and acquires data superimposed on frequency f22 to frequency f23.

Filter 1509 is, for example, a band elimination filter (BEF) which suppresses frequency f21 and frequency f22 to frequency f23 of the signal inputted from antenna 1501 and outputs the signal of suppressed frequency f21 and frequency f22 to frequency f23 to matching circuit 1510. That is, filter 1509 suppresses frequency f21 used in radio system 21 processed in the sixth sequence and frequency f22 to frequency f23 used in radio system 22 processed in the seventh sequence other than radio system 23 processed in the eighth sequence. For filter 1509, it is preferable to use a filter with the lowest possible pass loss of frequency f24 to frequency f25.

Matching circuit 1510 is connected in series between filter 1509 and amplifier 1511 which will be described later to provide impedance matching between filter 1509 and amplifier 1511. To be more specific, matching circuit 1510 converts an impedance of the signal inputted from filter 1509 so that the output impedance of matching circuit 1510 and the input impedance of amplifier 1511 have a complex conjugate relationship and outputs the converted impedance to amplifier 1511.

Amplifier 1511 amplifies the signal inputted from matching circuit 1510 and outputs the amplified signal to radio section 1512. In this case, the input impedance of amplifier 1511 and the output impedance of matching circuit 1510 have a complex conjugate relationship and the output impedance of amplifier 1511 is characteristic impedance H. Furthermore, amplifier 1511 has a gain of 0 dB or more at frequency f24 to frequency f25 and it is preferable to use an amplifier having the highest possible gain at frequency f24 to frequency f25 and having a low noise factor (NF) as well.

Radio section 1512 demodulates the signal inputted from amplifier 1511 and acquires data superimposed on frequency f24 to frequency f25.

The present embodiment processes a signal of a radio system that performs transmission in the sixth sequence, processes a signal of a radio system that performs only reception and a signal of a radio system that uses a band within the band of amplifier 1507 in the seventh sequence and processes a signal of a radio system that performs only reception and a signal of a radio system that uses a band within the band of amplifier 1511 in the eighth sequence.

As described so far, according to the present embodiment, effects similar to those in Embodiment 1 can be obtained with the portable radio apparatus made up of three processing sequences; sixth sequence that performs transmission/reception processing, seventh sequence and eighth sequence that perform only reception processing. Furthermore, the present embodiment uses an amplifier having the highest possible gain and a low noise factor (NF) for a reception band as well, can thereby suppress increases of noise as much as possible, amplify a desired received signal and improve reception sensitivity.

In the present embodiment, although the signals of radio system 22 and radio system 23 are amplified by an amplifier, the present embodiment is not limited to this but one or both of the amplifiers of radio system 22 and radio system 23 may be removed.

### Embodiment 5

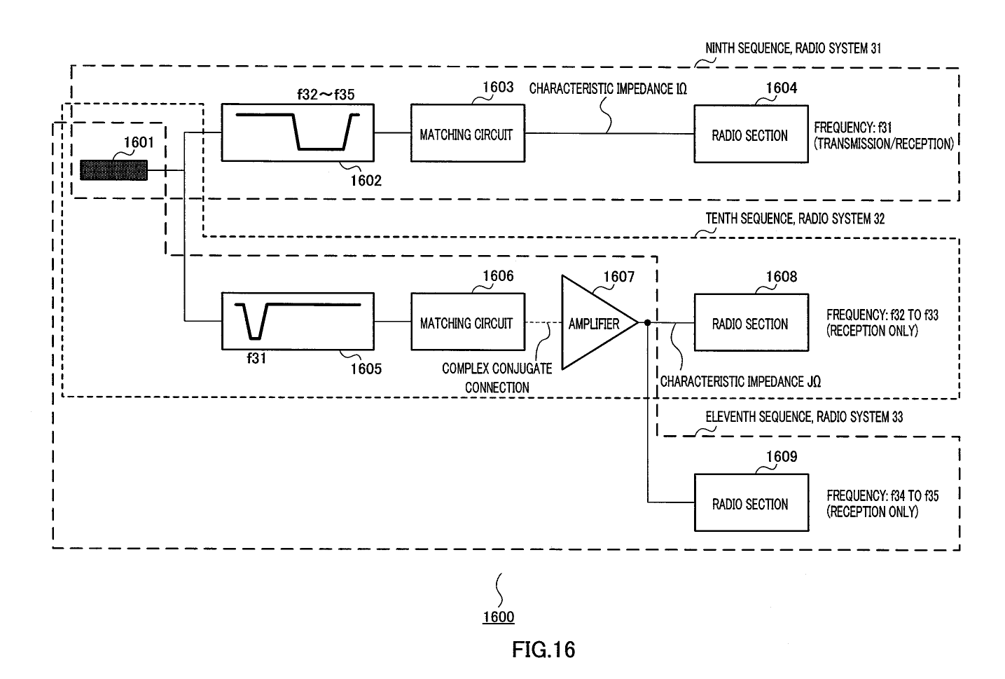

FIG. 16 is a block diagram illustrating a configuration of portable radio apparatus 1600 according to Embodiment 5 of the present invention.

Portable radio apparatus 1600 is mainly comprised of antenna 1601, filter 1602, matching circuit 1603, radio section 1604, filter 1605, matching circuit 1606, amplifier 1607, radio section 1608 and radio section 1609.

Furthermore, a sequence (hereinafter referred to as “ninth sequence”) made up of antenna 1601, filter 1602, matching circuit 1603 and radio section 1604 in portable radio apparatus 1600 performs both transmission processing of superimposing data on a signal of frequency f31 and reception processing of acquiring data superimposed on a signal of frequency f31. Furthermore, a sequence (hereinafter referred to as “tenth sequence”) made up of antenna 1601, filter 1605, matching circuit 1606, amplifier 1607 and radio section 1608 in portable radio apparatus 1600 performs only reception processing of acquiring data superimposed on a signal of frequency f32 to frequency f33. Furthermore, a sequence (hereinafter referred to as “eleventh sequence”) made up of antenna 1601, filter 1605, matching circuit 1606, amplifier 1607 and radio section 1609 in portable radio apparatus 1600 performs only reception processing of acquiring data superimposed on a signal of frequency f34 to frequency f35.

Hereinafter, the components of portable radio apparatus 1600 will be described in detail.

Antenna 1601 functions, for example, as a mono-pole antenna and includes an antenna element having an electrical length of ¼ wavelength or less. Antenna 1601 receives a signal of radio system 31 using frequency f31, a signal of radio system 32 using frequency f32 to frequency f33 and a signal of radio system 33 using frequency f34 to frequency f35 and outputs each received signal to filter 1602 and filter 1605. Furthermore, antenna 1601 transmits the signal of radio system 31 using frequency f31 inputted from filter 1602. Here, radio system 32 and radio system 33 have a wider band than radio system 31.

Filter 1602 is, for example, a band elimination filter (BEF) which suppresses frequency f32 to frequency f35 of a signal inputted from antenna 1601 and outputs the signal of suppressed frequency f32 to frequency f35 to matching circuit 1603. Furthermore, filter 1602 suppresses frequency f32 to frequency f35 of a signal inputted from matching circuit 1603 and outputs the signal of suppressed frequency f32 to frequency f35 to antenna 1601. That is, filter 1602 suppresses frequency f32 to frequency f33 used in radio system 32 processed in the tenth sequence and frequency f34 to frequency f35 used in radio system 33 processed in the eleventh sequence other than radio system 31 processed in the ninth sequence. For filter 1602, it is preferable to use a filter with the lowest possible pass loss of frequency f31.

Matching circuit 1603 is connected in series between filter 1602 and radio section 1604 which will be described later to provide impedance matching between filter 1602 and radio section 1604. To be more specific, matching circuit 1603 converts an impedance of the signal inputted from filter 1602 to characteristic impedance In.

Radio section 1604 demodulates the signal inputted from matching circuit 1603 and acquires data superimposed on frequency f31. Furthermore, radio section 1604 performs modulation of superimposing data on frequency f31 and outputs the modulated signal to matching circuit 1603.

Filter 1605 is, for example, a band elimination filter (BEF) which suppresses frequency f31 of a signal inputted from antenna 1601 and outputs the signal of suppressed frequency f31 to matching circuit 1606. That is, filter 1605 suppresses frequency f31 used in radio system 31 processed in the eleventh sequence other than radio system 32 and radio system 33 processed in the tenth sequence and eleventh sequence. For filter 1605, it is preferable to use a filter with the lowest possible pass loss of frequency f32 to frequency f35.

Matching circuit 1606 is connected in series between filter 1605 and amplifier 1607 which will be described later to provide impedance matching between filter 1605 and amplifier 1607. To be more specific, matching circuit 1606 converts an impedance of the signal inputted from filter 1605 so that the output impedance of matching circuit 1606 and the input impedance of amplifier 1607 have a complex conjugate relationship and outputs the converted impedance to amplifier 1607.

Amplifier 1607 amplifies the signal inputted from matching circuit 1606 and outputs the amplified signal to radio section 1608 and radio section 1609. In this case, the input impedance of amplifier 1607 and the output impedance of matching circuit 1606 have a complex conjugate relationship and the output impedance of amplifier 1607 is characteristic impedance J. Furthermore, for amplifier 1607, it is preferable to use an amplifier having a gain of 0 dB or more at frequency f32 to frequency f35, having the highest possible gain at frequency f32 to frequency f35 and having a low noise factor (NF) as well.

Radio section 1608 demodulates the signal inputted from amplifier 1607 and acquires data superimposed on frequency f32 to frequency f33.

Radio section 1609 demodulates the signal inputted from amplifier 1607 and acquires data superimposed on frequency f34 to frequency f35.

In the present embodiment, a signal of a radio system that performs transmission is processed in the ninth sequence, a signal of the radio system that performs only reception and a signal of a radio system that uses a band within the band of amplifier 1607 are processed in the tenth sequence or eleventh sequence.

Thus, according to the present embodiment, effects similar to those in Embodiment 1 can be obtained with the portable radio apparatus made up of three processing sequences; ninth sequence that performs transmission/reception processing, tenth sequence and eleventh sequence that perform only reception processing and share the amplifier.

In the present embodiment, although the signal of radio system 32 and the signal of radio system 33 are amplified by the amplifier, the present embodiment is not limited, but the amplifier may be removed. Furthermore, in the present embodiment, although the signal processed in the tenth sequence and the signal processed in the eleventh sequence are set to different frequency bands, the present embodiment is not limited to this, but signals of a radio system using the same or partially overlapping frequency bands may be processed in the tenth sequence and eleventh sequence.

In above Embodiment 1 to Embodiment 5, although each of signals of a plurality of radio systems is converted to a characteristic impedance and an impedance having a complex conjugate relationship therewith according to the band used, the present invention is not limited to this, but all signals of the plurality of radio systems may be converted to characteristic impedances or all signals of the plurality of radio systems may be converted to impedances having a complex conjugate relationship therewith to connect each circuit.

In above Embodiment 1 to Embodiment 5, although the sequence of the wide band radio system is used as a receive-only sequence, the present invention is not limited to this, but the sequence of the wide band radio system may be adapted so as to perform processing of both transmission and reception or only transmission. In this case, the amplifier needs to be removed.

Furthermore, in above Embodiment 1 to Embodiment 5, although a signal of a narrow band radio system and a signal of a wide band radio system are processed respectively, the present invention is not limited to this, but only signals of a plurality of wide band radio systems may be processed or only signals of a plurality of narrow band radio systems may be processed.

Furthermore, in above Embodiment 1 to Embodiment 5, although processing of both transmission and reception is performed in the processing sequence of a narrow band radio system, the present invention is not limited to this, but one of transmission and reception may be performed.

The disclosure of Japanese Patent Application No. 2008-280335, filed on Oct. 30, 2008, including the specification, drawings and abstract is incorporated herein by reference in its entirety.

### INDUSTRIAL APPLICABILITY

The portable radio apparatus according to the present invention is particularly suitable for use in simultaneously operating a plurality of radio systems by sharing one antenna element.

1.-7. (canceled)

8. A portable radio apparatus comprising:
an antenna;
a first suppressing section that suppresses a first frequency band of a signal received through the antenna;
a second suppressing section that suppresses a second frequency band of the signal received through the antenna;
an amplification section that amplifies the signal of the second frequency band suppressed by the second suppressing section;
a first radio section that demodulates the signal of the suppressed first frequency band and acquires data superimposed on the signal of the second frequency band;
a second radio section that demodulates the signal amplified by the amplification section and acquires data superimposed on the signal of the first frequency band;
a first matching circuit connected between the first suppressing section and the first radio section, that performs matching so that an impedance between the first suppressing section and the first radio section becomes a characteristic impedance; and
a second matching circuit connected between the second suppressing section and the amplification section, that performs matching so that impedances of the second suppressing section and the amplification section become complex conjugate with each other.

9. The portable radio apparatus according to claim 8, wherein:
the first radio section acquires Bluetooth data superimposed on the signal of the second frequency band; and
the second radio section acquires digital television data superimposed on the signal of the first frequency band.

10. The portable radio apparatus according to claim 8, wherein:
the first radio section performs at least one of processing of the demodulation and modulation of superimposing data on the signal of the second frequency band;
the second radio section performs only the demodulation;
the first suppressing section suppresses the first frequency band of the modulated signal when the first radio section performs the modulation; and
the antenna transmits the signal of the suppressed first frequency band.

11. The portable radio apparatus according to claim 8, wherein the second radio section acquires data superimposed on the signal of the first frequency band which is a wider band than the second frequency band.

12. The portable radio apparatus according to claim 8, wherein the antenna comprises an antenna element having ¼ wavelength or less.
